(19) United States
(12) Patent Application Publication
(10) Pub. No.: US 2005/0025347 A1
(43) Pub. Date: Feb. 3, 2005

(54) Medical viewing system having means for image adjustment

(76) Inventors: Sherif Makram-Ebeid, Dampierre (FR); Pierre Lelong, Nogent Sur Marne (FR); Bert Leo Alfons Verdonck, Eindhoven (NL); Jean-Pierre Franciscus Alexander Maria Ermes, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/499,944

(22) PCT Filed: Oct. 16, 2002
(86) PCT No.: PCT/IB02/05453

(30) Foreign Application Priority Data
Dec. 28, 2001 (EP) 01403381.5

(51) Int. Cl. G06K 9/00

(52) U.S. Cl. 382/128

(57) ABSTRACT

A medical viewing system including an imaging means (2,3) and image data processing means (5) is arranged to facilitate production of different images of a feature of interest such that the pose of the feature of interest is comparable in the different images. The image data processing means (5) estimates the pose of the feature of interest in a second image relative to the pose thereof in a first image, typically generated at a different time, and applies an affine transformation, for example to the second image, so as to produce a transformed second image in which the feature of interest has substantially the same pose as in the first image. The image data may also be processed so as to normalize the intensity characteristics of the images to be compared. Gross differences in pose can be eliminated by processing the image data so as to generate control data indicating how to set up the imaging apparatus to produce an image having the feature of interest oriented substantially in a desired pose.

### FIELD OF THE INVENTION

The present invention relates to a medical viewing system having means for image adjustment to facilitate comparison of medical images, as well as to a medical examination apparatus and computer program product.

### BACKGROUND OF THE INVENTION

With the widespread adoption of medical imaging technology, such as x-ray imaging apparatus, CT scanners and the like, there has been a need for improved medical viewing systems enabling the image data to be visualized in a form that is useful to medical practitioners. Most medical viewing systems associate with the imaging apparatus some computer-based data processing equipment capable of processing the image data and generating a viewable representation of the imaged element, for example a body part, organ, etc., in real-time. In general, it is desirable for such systems to be interactive, enabling the medical practitioner to influence the image that is acquired and/or the representation of the image data. Work stations remote from the imaging apparatus are also often used for post-processing of the acquired image data.

One medical viewing system designed to facilitate analysis of the movement of artificial joints is described in the article “An interactive system for kinematic analysis of artificial joint implants” by Sarojak et al, Proc. of the 36th Rocky Mountain Bioengineering Symposium, 1999. The aim of this system is to be able to generate images of total joint arthroplasty (TJA) implants in different positions, so as to be able to study the nature of the motions involved when the joint functions. In order to facilitate the analysis ofjoint motion, this system processes image data for each position of the joint, in order to be able to quantify the “pose” of the implant in the image in question. The “pose” is measured with reference to a computer aided design model of the implant.

It is often desirable to be able to compare medical images of the same feature of interest acquired at different times, typically so as to detect medically-significant changes. For example, in the field of orthopedic surgery, when a prosthesis, such as a replacement hip, is implanted, the prosthesis can cause changes in the surrounding structures. Moreover, the position of the prosthesis can change over time and the prosthesis can be subject to wear. In order to monitor such developments, it is desirable to generate an image of the prosthesis and its environment right after the operation implanting the prosthesis, and to generate follow-up images at intervals afterwards, such as after one week, then one month, etc., right up to several years later. By comparison of the images taken at different times, the medical practitioner can assess how the prosthesis is affecting its environment, and whether the prosthesis is moving and/or subject to wear.

When using current medical viewing systems, it is not a simple matter to compare medical images of the same feature of interest taken at different times. The position of the feature of interest relative to the imaging equipment is not necessarily constant between images, causing differences in the geometry of the feature of interest in the image. Furthermore, the images to be compared may be taken using different imaging devices and/or the settings of the imaging apparatus may be different between the images, causing differences in the relative intensities of pixels in the image. As indicated, these differences in the imaging conditions affect the images to be compared. Thus, when viewing the images to be compared it becomes difficult for the medical practitioner to differentiate between true changes in the feature of interest and its environment and apparent changes in the image, which are due merely to differences in the imaging conditions.

By the way, it is to be understood that in this document the expression “feature of interest” is used broadly to designate any feature or region in the body, whether human or animal, whether a bone, a vessel, an organ, a fluid, or anything else, and includes artificial elements implanted into or attached to the body.

### SUMMARY OF THE INVENTION

It is an object of the present invention to provide a medical viewing system having means to facilitate the comparison of medical images, especially medical images of the same feature of interest generated at different times.

More particularly, it is an object of the present invention to provide a medical viewing system having means to reduce, in separate medical images of the same feature of interest, discrepancies arising from differences in imaging conditions.

Comparison of separate medical images of a feature of interest is facilitated if the pose, or geometry, of the feature of interest in question is the same in the images to be compared. According to the present invention, the pose of a feature of interest captured in first and second images is compared and one of the images is transformed so that the feature of interest of interest adopts substantially the same pose as in the other image.

Additionally, the intensity characteristics of the images can be studied and a transformation performed so that the intensity profiles of the first and second images are more closely aligned with each other.

It can also be advantageous to associate with the viewing system of the present invention a method for avoiding gross differences in pose of the feature of interest from the first image to the second image. This method consists in generating control data and instructions indicating how to arrange the settings of the medical examination apparatus associated to the viewing system, such that an image will be obtained having feature of interest in a desired pose.

The control data for setting up the medical examination apparatus may be generated in a number of ways. For example, the pose of the feature of interest of interest in a first image can be analyzed (for example with reference to a model) and control data produced to set-up the imaging apparatus such that a second image can be produced having the feature of interest in the same pose as in the first image. Alternatively, a trial second image can be generated and the pose of the feature of interest in that trial second image can be compared with the pose thereof in a first image. The output data representing the set-up of the imaging apparatus is derived from the difference in pose between the first image and the trial second image. Once the imaging apparatus is set up in accordance with the output data, a “good” second image is produced in which the pose of the feature of interest should be much closer to the pose thereof in the first image.

Any remaining differences can be reduced by performing the image normalization of the present invention.

The control data may constitute instructions to the operator of the system as to how to change the set-up of the imaging apparatus and/or the position of the patient so as to obtain an image having the feature of interest in the desired pose. Alternatively, the control data may automatically control one or more parameters of the imaging apparatus. Moreover, the output control data may be indicative of desired values of one or more parameters of the imaging apparatus and/or indicative of changes to be made to such-parameters of the imaging apparatus, so as to obtain an image having the feature of interest of interest in the desired pose. The control data may additionally instruct the operator how to adjust parameters of the imaging apparatus related to the intensity profile of the image.

### BRIEF DESCRIPTION OF THE DRAWINGS

The invention is described in detail in reference to the following schematic drawings:

FIG. 1A is a diagram illustrating the main components of a medical examination apparatus associated to a viewing system according to a first embodiment of the present invention; and FIG. 1B illustrates the six degrees of freedom of the imaging apparatus with respect to the patient.

FIG. 2 is a flow diagram indicating major steps performed by image data processing means in the system of FIG. 1;

FIG. 3 relates to an example hip prosthesis, in which FIG.3A shows an x-ray image of the example hip prosthesis, such as would be produced in the system of FIG. 1; and FIG. 3B shows the outline of a discriminating portion of the hip prosthesis in the image of FIG. 3A;

FIG. 4 relates to another image of the same example hip prosthesis, in which FIG. 4A shows another x-ray image of the example hip prosthesis; and FIG. 4B shows the outline of the discriminating portion of the hip prosthesis in the image of FIG. 4A; and

FIG. 5 shows the main steps in a preferred procedure for generating control data for use in controlling the settings of the medical examination apparatus in the system of FIG. 1.

### DESCRIPTION OF EMBODIMENTS

The present invention will be described in detail below with reference to embodiments in which x-ray medical examination apparatus is used to produce images of a hip prosthesis. However, it is to be understood that the present invention is applicable more generally to medical viewing systems using other types of imaging technology and there is substantially no limit on the human or animal feature of interest that can be the object of the images.

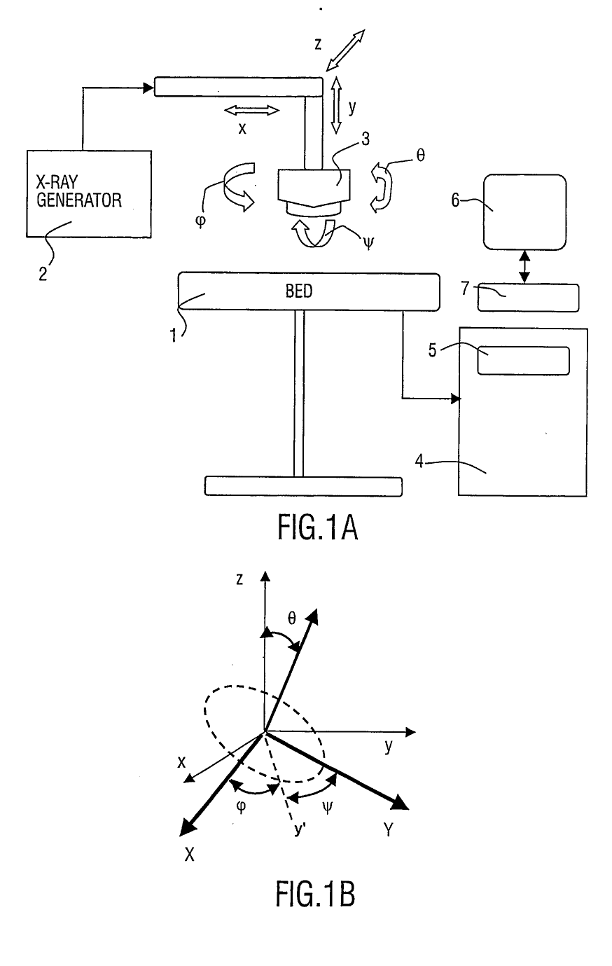

FIG. 1A is a diagram showing the main components of a medical examination apparatus according to a first embodiment of the present invention. The medical examination apparatus of this embodiment includes a bed 1 upon which the patient will lie, an x-ray generator 2 associated with x-ray imaging device 3 for producing an image of a feature of interest of the patient, and a viewing system 4 for processing the image data produced by the x-ray medical examination apparatus. The viewing system has means to enable different images of the feature of interest to be produced such that the pose of the feature of interest is comparable in the different images. Typically, the different images will be generated at different times and a medical practitioner will wish to compare the images so as to identify developments occurring in the patient's body during the interval intervening between the taking of the different images.

The patient may be presented to the x-ray medical examination apparatus on a support other than a bed, or may stand so as to present the whole or a part of himself in a known positional relationship relative to the imaging device 3, in a well-known manner. Similarly, in this embodiment known x-ray imaging device may be used. The imaging system 4 includes data processing means 5, a display screen 6 and an inputting device, typically a keyboard and/or mouse 7 for entry of data and/or instructions. The imaging system 4 may also include or be connected to other conventional elements and peripherals, as is generally known in this field. For example, the imaging system may be connected by a bus to local or remote work stations, printers, archive storage, etc.

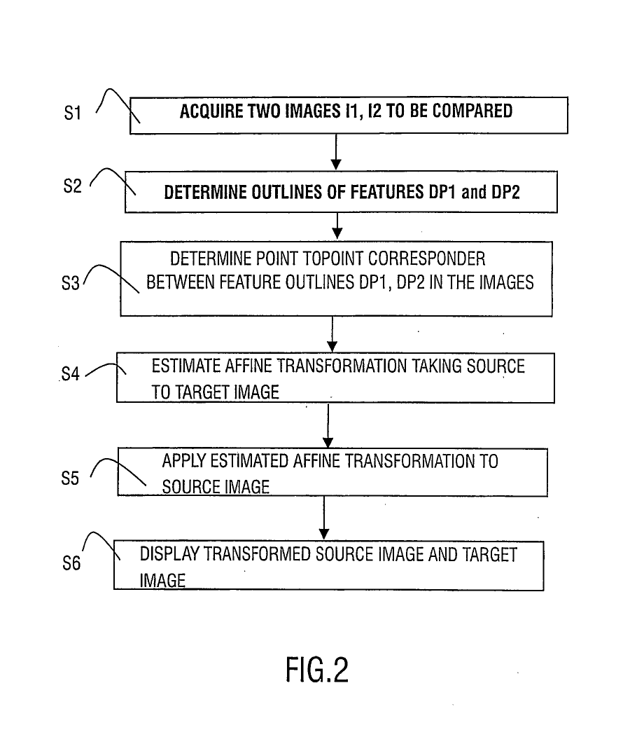

FIG. 2 is a flow diagram useful for understanding the functions performed by the data processing means 5 of the medical viewing system of FIG. 1. Preferably, before the image data processing steps described below are applied to images produced by the x-ray imaging apparatus 3, standard x-ray image calibration and correction procedures are applied to the images. Such procedures include, for example, corrections for pincushion and earth magnetic field distortions, and for image intensifier vignetting effects.

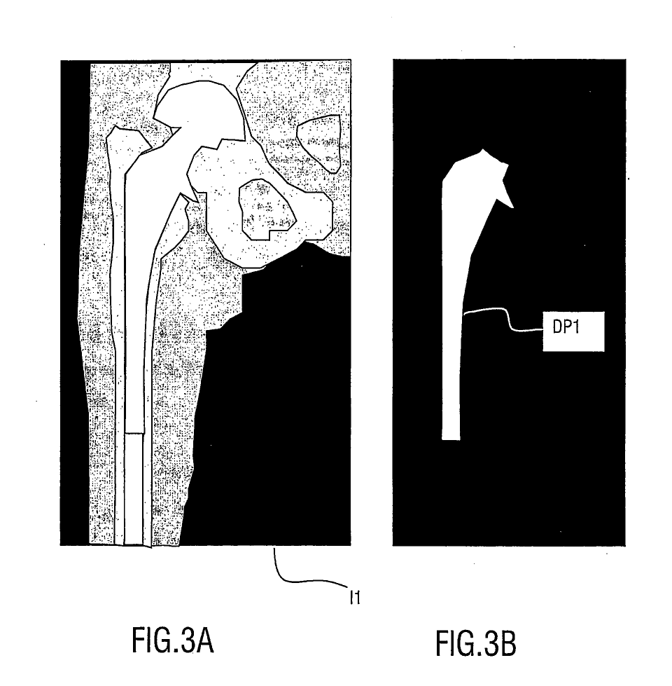

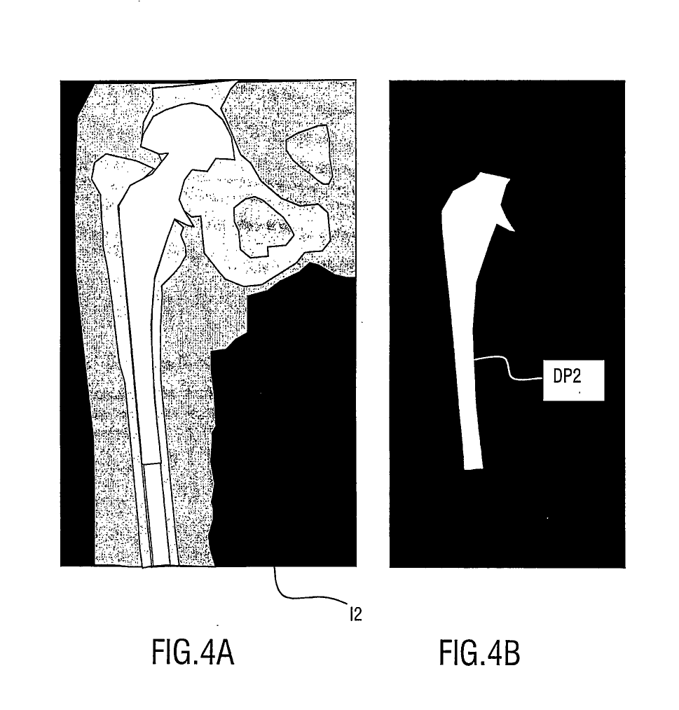

As shown in FIG. 2, the viewing system has means to carry out the following steps S1 to S6. In a step S1, two images, denoted by I1 and I2, are acquired of the feature of interest, in a given patient. Typically, these images will be acquired at different times using the x-ray medical examination apparatus 3 which produces an image of the appropriate region of the patient's body, for example the hip region when generating images of a hip prosthesis. The image data representing the images is either already in digital form as output from the x-ray imaging apparatus, or it is converted into digital form by known means. In the present embodiment, it is assumed that the table 1 upon which the patient lies has integrated therein a flat-panel detector providing digital x-ray image data. Each image I1, I2 is, in effect, a two-dimensional (2D) representation of the imaged region of the patient's body. FIG. 3A shows a schematic drawing representing an example of a typical x-ray image that would be obtained of a hip prosthesis, and FIG. 4A shows another schematic drawing representing an image of the same hip prosthesis, taken at a different time.

In order for the medical practitioner to be able to identify medically significant differences between the two images of the feature of interest in question, it is necessary to eliminate “artificial” differences arising from differences in the imaging conditions. The main “artificial” difference arises from differences in the pose of the two images. Accordingly, the difference in pose is estimated.

Firstly, in a step S2, the digital image data is processed to identify the outline of the feature of interest of interest in each image. This processing may use well-known segmentation techniques, such as those described in chapter 5 of the “Handbook of Medical Imaging Processing and Analysis”, editor-in-chief Isaac Bankman, published by Academic Press. In fact, for a hip prosthesis, only a portion, called discriminating portion, of the outline is needed, and is always visible. Thus, for such a case, the outline of the discriminating portion is identified in step S2. FIG. 3B and FIG. 4B respectively show the outline of the discriminating portion DP1, DP2 of the hip prosthesis as it appears in FIG. 3A and FIG. 4A.

Secondly, in a step S3 known contour matching techniques are applied resulting in a point to point correspondence between the two outlines. Typically, the data representing the outline-in one image, hereafter called the “source image”, which is the discriminating portion, for instance DP1, is traversed and, for different positions (run lengths) along the outline, the change in the angle of the tangent to the outline at that point is recorded. This data is plotted and produces a curve having a characteristic shape. The same processing is applied to the data representing the outline of the other image, hereafter called the “target image”, which is the corresponding discriminating portion, for instance DP2, and a corresponding data plot is obtained.

Next, in a step S4, the affme transformation having six degrees of freedom, including one for in-plane rotation, one for change in scale and two for translations for partial compensation of the 3D degrees of freedom illustrated by FIG. 1A and FIG. 1B; this affine transformation is needed to transform the outline as it appears in the source image to its orientation in the target image is calculated based on the changes required to align the characteristic “change in tangent” curve plotted for the source image with the characteristic “change in tangent” curve plotted for the target image. This affine transformation is then applied to the source image, in a step S5, in order to produce a transformed source image in which the pose of the feature of interest should match the pose thereof in the target image. This transformation may be termed a “geometrical-normalization” of the images that are to be compared. It provides image adjustment.

Finally, in a step S6, the target image and the transformed source image are displayed, typically in juxtaposition (side by side, one above the other, or subtracted the one from the other, etc.), so that the medical practitioner can evaluate the medically significant differences between them. Alternatively, the displayed image can be the difference between the target image and the transformed source image. Minute differences between the images can then be localized (in some cases with sub-pixel precision).

The image intensities in the transformed source image should be near the corresponding intensities in the target image. However, in some cases there may be a significant discrepancy, for example because different x-ray imaging machines were used to produce the two images (different machines having different intensity profiles). In such a case it can be advantageous to perform an intensity normalization process before display of the images (in other words, in-between steps S5 and S6 of FIG. 2).

The intensity normalization technique preferably consists in applying a best-fit procedure to minimize the discrepancy between intensities at corresponding points in the target image and transformed source image. The best-fit procedure should be applied within a region around the prosthesis, which cannot move independently of the prosthesis. The extent and localization of this region depends upon the particular prosthesis (or other feature of interest) being examined and can readily be determined by the medical practitioner from anatomical considerations. As an example, with regard to a hip prosthesis, the relevant region consists in a part of the femur near the hip prosthesis together with a portion of the patient tissues around it. The image data processing means 5 can be programmed to identify automatically the image region to be processed, or the operator can identify the region to the system by using the keyboard or other inputting device 7 (interactive system). For example, the operator could use a pointing device with reference to a displayed image (target image or transformed source image) to delimit the boundary of the region to be processed.

Once the region to be processed has been identified, a mathematical law (for example a polynomial) is sought which would transform each pixel intensity in one image (for example the transformed source image) into a value as near as possible to the corresponding intensity in the other image (for example the target image) within the selected region. This can be done by using known robust least square fitting techniques. For example, the intensity values of pixels in one image (for example the transformed source image) are plotted in an x,y co-ordinate frame against the intensity values of the corresponding pixels in the other image (target image). Curve-fitting techniques are then applied to find a curve passing through the various points. Typically an s-shaped curve is required.

The determined polynomial function is then applied to the one image (e.g. transformed source image) and the transformed intensities should agree closely with the intensities in the other image (e.g. target image), possibly with the exception of some outlying pixels.

In many cases the above-described image normalization processes (geometrical and intensity normalization) are sufficient to enable the “artificial” differences between images of a feature of interest to be eliminated or substantially reduced. However, in some cases the difference in the pose of the feature of interest is so great from a first image to a second image that it cannot be satisfactorily reduced by image processing alone. In such a case, it is advantageous to take measures to ensure that an image is generated in which the pose is fairly close to a desired pose (for example, the pose already observed in another image of the feature). The preferred technique for achieving this is to generate control data indicating how the imaging apparatus should be set up in order to generate an image having the feature of interest in the desired pose. This control data can constitute instructions for the operator of the imaging apparatus (and can be displayed, printed out, etc.) or can be used directly to control the imaging apparatus without human intervention.

When applying this technique to avoid gross differences in pose of the feature of interest, various approaches are possible. For example, a “desired” pose can be selected (for example an “ideal” pose which would provide the medical practitioner with maximum information), by referring to a reference, such as a computer-aided design (CAD) model of the hip prosthesis, and then measures taken to ensure that all images to be compared have the feature of interest in this selected pose. Or, as another example, a first one of the images to be compared can be generated, the pose of the feature of interest in the first image can be estimated and measures taken to ensure that the other images to be compared have the in the same pose as in the first image.

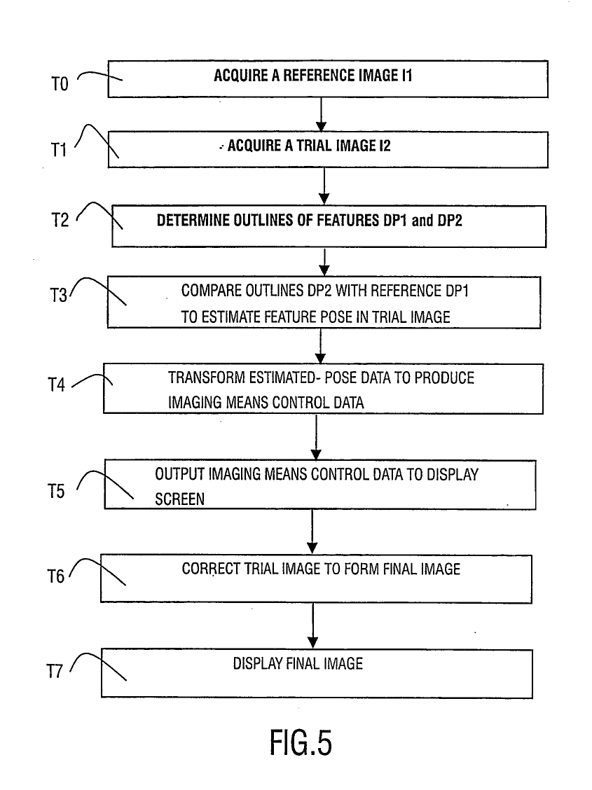

Whichever approach is taken, the possible procedure is the same and the main steps thereof are indicated in FIG. 5. First of all, in a step T1, a trial image is acquired. Typically this will be a “test shot” obtained using the x-ray imaging apparatus 2,3 of the system shown in FIG. 1. Next, in a step T2, the outline of the feature of interest (or a discriminating portion thereof) is extracted using known segmentation techniques. Then, in a step T3, the pose of the feature of interest is estimated by comparison with a reference representation of the feature acquired in a step T0. In the case of a prosthesis, the reference representation can be CAD data supplied by the manufacturer of the prosthesis. A preferred pose-estimation technique is that described in the article by Sarojak et al cited above. This technique involves generating 2D projections from a 3D reference representation of the feature of interest, and finding the 2D projection in which the pose of the feature of interest best matches its pose in the trial image.

The estimated-pose data is then transformed, with reference to desired pose data, in order to generate control data in step T5, indicating how the set-up of the x-ray imaging apparatus should be controlled or changed in order to obtain an image, in step T6, in which the interest has the desired pose. As mentioned above, the desired pose data can be a pose derived from an earlier image of the same feature of interest or a pose derived from theoretical considerations. The corrected image is displayed in T7.

In an example of embodiment of the present invention the medical viewing system of FIG. 1 integrates the image normalization aspect of the present invention with the control-data generating technique described above. The two aspects of the integrated system can interact in different ways.

For example, in this system, when a “follow-up image” is generated and it is desired to compare it with another image of the same feature of interest (for example an image obtained at an earlier time), here called a “comparison image”, an attempt can first be made to normalize the image data of the follow-up image and the comparison image using the geometrical normalization and/or intensity normalization techniques described above. If the resulting images are sufficiently similar then the processing ends there. However, if there are still significant differences between the images, typically due to differences in imaging geometry, then the image data processing means 5 implements the control data generating procedure described above. Thus, the image data processing means 5 estimates the pose of the feature of interest in the follow-up image relative to the pose thereof in the comparison image and outputs control data indicating how the imaging apparatus should be set up in order to produce an improved follow-up image.

Alternatively, or additionally, in the integrated system, before any follow-up image is produced, the control-data generating technique can be used to generate control data indicating how the imaging apparatus should be set up in order to obtain a follow-up image in which the feature of interest is in a desired pose. Later, once one or more images have been obtained using the apparatus set-up according to the control data, the geometry and/or intensity characteristics of these images can be normalized with reference to a comparison image (which itself can have been generated using the imaging apparatus set-up in accordance with predetermined control data).

The drawings and their description hereinbefore illustrate rather than limit the invention. It will be evident that there are numerous alternatives that fall within the scope of the appended claims. In this respect the following closing remarks are made.

As mentioned above, the imaging apparatus is not limited to x-ray devices and the imaged feature can be substantially any feature of interest including artificial elements such as prostheses/implants. Moreover, although the present invention has been described in terms of image normalization to facilitate the comparison of two images, it is to be understood that the techniques of the invention can be applied so as to enable a series of three or more images to be normalized for comparison. Also, although it will in general be desired to display the normalized image data, other forms of output are also possible, for example, printing the normalized images and/or an image representing the difference between them, outputting the image data to a storage device, etc.

Moreover, the above-described embodiments generally involve the transformation of image data relating to a source image so that the geometry and intensity characteristics thereof conform more closely to those of a target image. However, it is to be understood that it is largely immaterial which of the images is transformed. Thus, image data relating to the source image could be transformed with regard to geometry but image data relating to the target image transformed in order to normalize the intensity characteristics of the two images. Similarly, in general it does not matter whether the transformed image data relates to an image generated earlier in time or later in time than the image(s) with which it is to be compared. It is even possible to normalize the geometry characteristics of the images to be compared by transforming both images to a reduced extent, rather than transforming one image to a greater extent. The same holds true for the intensity normalization.

Furthermore, in certain embodiments of the invention the pose of a feature of interest in an image is estimated using a pattem-matching technique with reference to 2D projections from a 3D reference, but other pose estimation techniques can be used.

The above description assumes that at least one of the images to be compared, whose data is processed by the image data processing means 5, is generated by the x-ray imaging apparatus 2, 3 forming part of the overall medical viewing system of the invention. However, in theory, image data relating to images generated by external devices could be input to and processed by the image processing means 5. Moreover the present invention relates also to a work station which does not incorporate imaging apparatus.

Any reference sign in a claim should not be construed as limiting the claim.

1. Medical viewing system comprising imaging apparatus (2,3) and image data processing apparatus (5), wherein the image processing apparatus comprises;
pose estimation means adapted to process data relating to first and second images of a feature of interest so as to estimate the relative pose of the in the second image compared with the pose thereof in the first image, and
image transformation means adapted to transform image data relating to said first and/or second image whereby to align the pose of the feature of interest in the two images.

2. Medical viewing system according to claim 1, wherein the image transformation means has calculation means to calculate the affine transformation required to align the pose of the feature of interest in the two images.

3. Medical viewing system according to claim 1, wherein the image transformation means has further computing means to compare the intensities of pixels in the first and second images whereby to determine and apply a transformation necessary to normalize the intensity characteristics of said first and second images.

4. Medical viewing system according to claim 1, and comprising means for inputting to the pose estimation means image data produced by the imaging apparatus (2,3).

5. Medical viewing system according to claim 1, wherein the image data processing apparatus (5) comprises means for generating control data indicating how to set up the imaging apparatus (2,3) so as to produce an image having the feature of interest in a desired pose.

6. Medical examination apparatus comprising an imaging device (2,3) and a viewing system (4) as claimed in claim 1, including image data processing means (5) and imaging means (6), wherein the image data processing means (5) comprises:
pose estimation means for processing data relating to first and second images of a feature of interest so as to estimate the relative pose of the feature of interest in the second image compared with the pose thereof in the first image, and
image transformation means for transforming image data relating to said first and/or second image whereby to align the pose of the feature of interest in the two images, and wherein said imaging means (6) display the processed images.

7. The apparatus according to claim 6, wherein the image transformation means has calculation means to calculate the affine transformation required to align the pose of the feature of interest in the two images.

8. The apparatus according to claim 1, wherein the image transformation means has further computing means to compare the intensities of pixels in the first and second images whereby to determine and apply a transformation necessary to normalize the intensity characteristics of said first and second images.

9. The apparatus according to claim 6, and comprising means for inputting to the pose estimation means, image data produced by the imaging device (2,3).

10. The apparatus according to claim 6, wherein, in use:
the pose estimation means processes data relating to a first and a second images, respectively generated by the imaging device (2,3) at different times, so as to estimate the relative pose of an imaged feature of interest in the second image compared with the pose thereof in the first image, and
the pose correction means processes data generated by the pose estimation means representing the relative pose of the feature of interest so as to produce imaging means control data indicative of settings of the imaging means (2,3) required to produce a further image having the feature of interest in the same pose as the pose thereof in the first image.

11. Computer program product having a set of instructions, when in use on a general-purpose computer, to cause the computer to perform the following steps:
to process data relating to first and second images of a feature of interest so as to estimate the relative pose of an imaged feature of interest in the second image compared with the pose thereof in the first image, and
to transform image data relating to said first and/or second image whereby to align the pose of the feature of interest in the two images.

12. Computer program product according to claim 11, wherein the image transformation step comprises the step of calculating the affine transformation required to align the pose of the feature of interest in the two images.

13. Computer program product according to claim 11, wherein the image transformation step further comprises the steps of comparing the intensities of pixels in the first and second images, determining and applying a transformation necessary to normalize the intensity characteristics of said first and second images.

14. Computer program product according to claim 11 having a set of instructions, when in use on a general-purpose computer, to cause the computer to perform the step of generating control data indicating how to set up imaging device (2,3) so as to produce an image having the feature of interest in a desired pose.
